(19) United States
(12) Patent Application Publication
(10) Pub. No.: US 2016/0375664 A1
(43) Pub. Date: Dec. 29, 2016

(54) Protective Marking Element on Disposable Plastic and Paper Products

(71) Applicants: Stefan TIMKO, JASOV (SK); Roman HILOVSKÝ, Mokrance (SK)

(72) Inventors: Roman HILOVSKÝ, Mokrance (SK); Stefan TIMKO, JASOV (SK)

(21) Appl. No.: 15/191,547

(22) Filed: Jun. 24, 2016

(30) Foreign Application Priority Data
Jun. 26, 2015 (SK) 120-2015

(51) Int. Cl. B32B 29/00

(52) U.S. Cl. CPC B32B 29/002

(57) ABSTRACT

There is a description of disposable plastic or paper product with protective marking element , which is formed from marking tape (2), which from one side is fastened over the sticky layer (11) to a disposable product (1) and on the other side of the marking tape (2) is the colour indicator (3) applied.

### TECHNICAL FIELD

The invention concerns the protection flag of element for the disposable plastic or paper products and the method of its produce, intended to prevent the multiple use of disposable plastic and paper products.

### BACKGROUND OF THE RELATED ART

Presently there are known cases of clear film for disposable products, which give information to users when opening the package that is has been opened for the first time and no other unauthorized person used this disposable product before. A disadvantage of this solution is a functional unreliability and the possibility of repackaging of this disposable product.

Other known solution is described in the published Czech patent application PV No. 3 385—97 paper entitled Paper products for single use with the indicator means, wherein indicator means give a visually recognizable signal to a user that required properties are not maintained if the paper product gets soaked with a liquid , the indicator will disappear. The disadvantage of this solution is that the user may be misled by the fact that he does not make sure the fact whether the manufacturer has joined the indicator mean to a particular paper product or not.

Other known solution is described in the specification to the Czechoslovak copyright certificate No. 260 773 entitled Paint—setting machine for tapes or hoses, made from plastic which are separated to make marking sleeves or labels. The disadvantage of this solution is not only a great difficulty of fixation of the dye on disposable products, but also the impossibility of determining whether this disposable product was used before by another user.

Another known solution is described in European Patent EP No. 1 532 002, entitled The durable security labelling and safety subjects using this labelling ,where the security marking is not resistant only to chemical and mechanical damage, as well as a fluid.

A disadvantage of this solution is the impossibility of its use for paper and plastic disposable products.

### SUMMARY OF THE INVENTION

The above mentioned disadvantages are considerably eliminated by the protective marking element for the disposable plastic and paper products, according to this invention, which is characterized in that it consists of at least one marking tape ,which is attached to one side colour light and the second side marking tape is through an adhesive layer affixed to a disposable product.

Preferable is that a disposable product is a disposable hygienically harmless straw and/or disposable hygienically harmless cutlery and/or disposable hygienically harmless bowl and/or disposable hygienically harmless plate and/or disposable hygienically harmless tray and/or disposable hygienically harmless cup and/or disposable hygienically harmless bottle and/or disposable hygienically harmless box and/or disposable hygienically harmless salver and/or disposable single tray and/or disposable tablecloth and/or disposable non-harmful thermos.

### BRIEF DESCRIPTION OF DRAWINGS

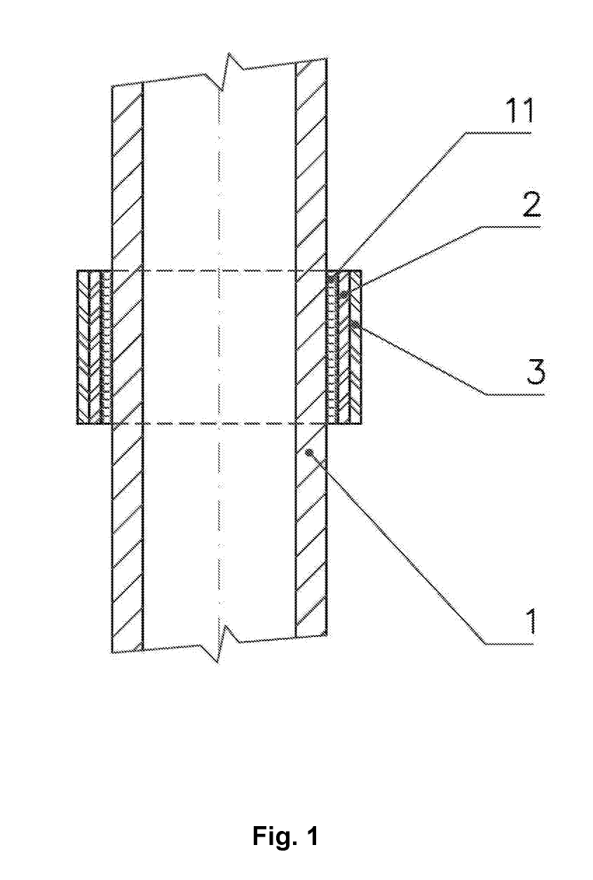

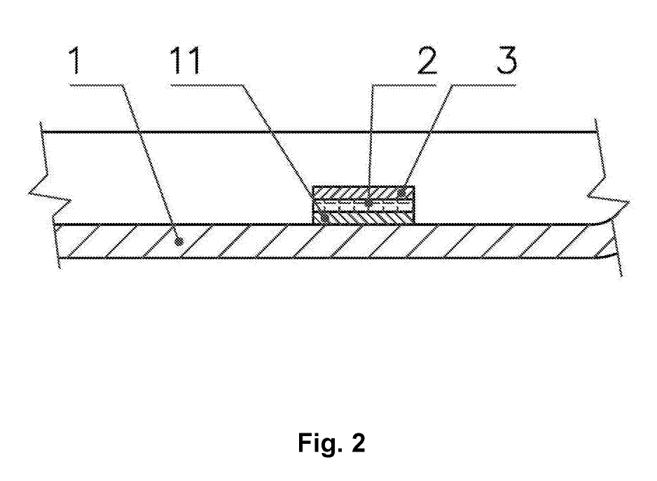

Technical solution will be closer explained with drawings, wherein FIG. 1 is a schematic representation of protective marking element on a disposable circle product and FIG. 2 is a schematic representation of protective marking element on a disposable flat product.

In FIG. 1 and FIG. 2, unit 1 represents disposable product, unit 11 represents sticky layer, unit 2 represents marking tape, and unit 3 represents colour indicator.

### DETAILED DESCRIPTION OF ILLUSTRATIVE EMBODIMENT

### Example No. 1

Protective marking element for disposable plastic and paper products, according FIG. 1 is made of marking tape 2, which is a food grade paper. On one side of the tape 2 is a thin sticky layer applied 11, which is a food grade glue. Marking tape 2 is over the sticky layer 11 fastened to a disposable product 1. On the other side of the tape 2 is a colour indicator applied 3, which is powder food grade coloring.

### INDUSTRIAL APPLICABILITY

Protective marking element for disposable plastic and paper products according this technical solution is possible to use for prevention of multiple use of disposable plastic and paper products, such as disposable straws, disposable cutleries, disposable bowls, disposable plates, disposable trays, disposable cups, disposable bottles, especially in buffets and fast food restaurants.

What is claimed is:

1. Protective marking element for disposable plastic and paper products characterized in that it consists of at least one marking tape (2) to which it is attached to one side coloured light (3) and the second side marking tape is through an adhesive layer (11) secured to the disposable product (1).

2. The protective marking element for disposable plastic and paper products ,according to claim 1, characterized in that the disposable product (1) is a disposable hygienically harmless straw and /or disposable hygienically harmless cutlery and/or disposable hygienically harmless bowl and/or disposable hygienically harmless plate and/or disposable hygienically harmless tray and/or disposable hygienically harmless cup and/or disposable hygienically harmless bottle and/or disposable box and/or disposable salver and/or disposable single tray and/or disposable tablecloth and /or disposable hygienically harmless thermos.
